(19) United States
(12) Patent Application Publication
(10) Pub. No.: US 2003/0063203 A1
(43) Pub. Date: Apr. 3, 2003

(54) Fault pixel correcting apparatus

(75) Inventor: Yoshinori Ohno, Tokyo (JP)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: Olympus Optical Co., Ltd., Tokyo (JP)

(21) Appl. No.: 10/262,093

(22) Filed: Oct. 1, 2002

(30) Foreign Application Priority Data
Oct. 3, 2001 (JP) 2001-307367

(51) Int. Cl. H04N 9/64

(52) U.S. Cl. 348/247

(57) ABSTRACT

A fault pixel correcting apparatus in which: image signal taken at CCD is digitized at an analog-to-digital converter and then recorded to an image buffer; surrounding pixels in a predetermined size are read into a line buffer by an input/output control section based on location information of the fault pixel recorded at a defect location recording ROM; integrated index values are obtained from a plurality of index values in predetermined directions at an index value computing section; a direction having maximum correlation is obtained at a direction computing section; and a correction value of the fault pixel is computed at a correction value computing section by using the surrounding pixels belonging to the direction having the above correlation. An accurate correction is thereby possible even in the case of a complicated edge structure or of successively occurring fault pixels.

This application claims benefit of Japanese Application No. 2001-307367 filed in Japan on Oct. 3, 2001, the contents of which are incorporated by this reference.

### FIELD OF THE INVENTION

The present invention relates to apparatus for correcting fault pixels occurring in solid-state image pickup devices, and more particularly relates to a fault pixel correcting apparatus in which a high-quality correction is possible even when the fault pixels occur in succession.

In recent years, image pickup apparatus such as digital cameras using solid-state image pickup device are used in various ways. The number of pixels to be used in a solid-state image pickup device tends to increase from year to year and this accompanies an increase also in the occurrence of fault pixels. Among those techniques which have been used in dealing with such a problem are: a previous recording of location of fault pixels at an inspection in the manufacturing process so as to replace such recorded fault pixels by adjoining pixels; and an interpolation using a median or mean value of surrounding pixels. By these techniques, however, an occurrence of discontinuity is possible at the corrected spot, for example, when a boundary in gradations occurs in the vicinity of the fault pixel or when contrast changes steeply.

To solve these problems, a technique has been proposed as disclosed in Japanese Patent Publication No. 2808813. In this technique, absolute values of the difference in signal level between two adjoining pixels are computed respectively of a total of five pixels, i.e., for those pixels that adjoin the fault pixel at one pixel before and after and for those three pixels that adjoin the fault pixel in the directly preceding line. The relative magnitudes of these differences are then compared with each other to classify the surrounding of the fault pixel into a pattern. A correction of the fault pixel is performed in accordance with the result of the classification.

Also, as disclosed in Japanese patent laid-open application Hei-8-9394, in order to display a high-quality image and avoid an adverse effect on the displayed image, intensity averages are computed of the pixels of the respective colors surrounding the fault pixel and a ratio is obtained between the intensity average of the observed color pixels and the intensity average of other color pixels. In this method, multiplying the original image signal by the thus computed value of such ratio and a median filtering are effected to obtain a signal which is free of a harmful signal.

In the correction circuit disclosed in the above Japanese Patent Publication No. 2808813, however, an error is possible in recognizing a pattern, since such pattern is identified only by the level differences among the pixels adjoining, before and after the fault pixel and the three pixels adjoining the fault pixel in the directly preceding line. For example, if as shown in FIG. 1A the luminance level differences are small among those adjoining pixels that are before (left side), upper left from and directly above the fault pixel (i.e, the fault pixel marked by “?”), it is determined as a vertical pattern. For this reason, the location of the fault pixel is interpolated by the value of the adjoining pixel directly above. A case of pattern ascending toward the upper-right direction as shown in FIG. 1B, however, is also possible. An accurate pattern classification thus cannot be performed. Further, if, for example, fault pixels occur in succession, a failure in identifying a pattern occurs due to the fact that a fault pixel is included in the adjoining pixels to be referred to.

Furthermore, fault pixels as used herein means pixels which are faulty or have some defect and which include white defects and black spot defects where a signal of white level or black level is outputted irrespective of the level of the incident light. In the correction method disclosed in the above Japanese patent laid-open application Hei-8-9394, defects are corrected under the assumption that the output value of a fault pixel is increased in accordance with the level of the incident light. For this reason, the fault pixels of white defect and black spot defect cannot be corrected. Further, in the case of an image pickup device having a color filter such as of Bayer-type where frequencies of occurrence are different among the colors is disposed on the front surface thereof, a loss of high-frequency components contained in a pixel has been a problem, since a correction is to be made by using an average of pixel signals of the same color at distant locations even for the defect of the pixel of color which occurs at a higher frequency. Moreover, if another fault pixel is included in the surroundings of the fault pixel, there has been a problem that an accurate correction cannot be performed due to the fact that the obtained average contains a fault pixel.

### SUMMARY OF THE INVENTION

In view of the above, it is an object of the present invention to provide fault pixel correcting apparatus which is capable of accurate correction even when a complicated edge structure occurs in the surroundings of a fault pixel or when fault pixels occur in succession.

It is another object of the invention to provide a fault pixel correcting apparatus in which correction is possible even of the fault pixels of white defect or black spot defect.

It is a further object of the invention to provide a fault pixel correcting apparatus in which an accurate correction is possible without a loss of high-frequency components in solid-state image pickup devices having color filters having different frequencies of occurrence so as to eliminate an erroneous operation even when another fault pixel exists in the surroundings of the fault pixel.

In accordance with a first aspect of the invention, there is provided a fault pixel correcting apparatus for correcting a fault pixel in solid-state image pickup device, including: defect storing means for storing location information of the fault pixel; pixel read means for reading surrounding pixels of the fault pixel based on the location information stored at the defect storing means; index value computing means for computing an integrated index value from a plurality of edge intensity index values concerning predetermined directions in the surrounding pixels read by the pixel read means; direction computing means for computing a direction having a maximum correlation based on the integrated index value computed at the index value computing means; and correction value computing means for computing a correction value of the fault pixel from surrounding pixels selected based on the direction computed by the direction computing means.

A first embodiment shown in FIGS. 2 to 8C corresponds to an embodiment of the fault pixel correcting apparatus according to the first aspect. Of the constituent features of the fault pixel correcting apparatus according to the first aspect: the defect storing means, pixel read means, index value computing means, direction computing means, and correction value computing means correspond to defect location recording ROM 205, input/output control section 200, index value computing section 202, direction computing section 203, and correction value computing section 204, respectively, of the first embodiment.

In the first embodiment shown in FIG. 2 to which the first aspect is applied: image signal taken at CCD 102 is digitized at an analog-to-digital converter 103 and then recorded to an image buffer 104; and surrounding pixels in a predetermined size are read into a line buffer 201 by the input/output control section 200 based on the location information of the fault pixels recorded at the defect location recording ROM 205. Integrated index values are then obtained from a plurality of index values in predetermined directions at the index value computing section 202; a direction having maximum correlation is obtained at the direction computing section 203; and a correction value of the fault pixel is computed at the correction value computing section 204 by using the surrounding pixels belonging to the direction having the above correlation.

In this manner, a direction having high correlation is obtained from the surrounding pixels of the fault pixel and the surrounding pixels belonging to such direction are used to compute a correction value. In that process, a plurality of index values are obtained with respect to predetermined direction and these are integrated to form an index value of such direction. Thus the obtained index value is accurate and the efficiency in detecting the direction is high so that an accurate correction of a fault pixel becomes possible even in a complicated image such as an edge region.

In accordance with a second aspect of the invention, there is provided a fault pixel correcting apparatus for correcting a fault pixel in solid-state image pickup device having color filters disposed on a front surface thereof, including: defect storing means for storing location information of the fault pixel; pixel read means for reading surrounding pixels of the same color as the fault pixel of the colors of the color filters disposed on the front surface of the solid-state image pickup device based on the location information stored at the defect storing means; index value computing means for computing integrated index values from a plurality of edge intensity index values concerning predetermined directions in the surrounding pixels of the same color as the fault pixel read by the pixel read means; direction computing means for computing a direction having a maximum correlation based on the integrated index values computed at the index value computing means; and correction value computing means for computing a correction value of the fault pixel from surrounding pixels selected based on the direction computed at the direction computing means.

The first embodiment shown in FIGS. 2 to 8C corresponds to an embodiment of the fault pixel correcting apparatus according to the second aspect. Of the constituent features of the fault pixel correcting apparatus according to the second aspect: the defect storing means, pixel read means, index value computing means, direction computing means, and correction value computing means correspond to defect location recording ROM 205, input/output control section 200, index value computing section 202, direction computing section 203, and correction value computing section 204 of the first embodiment, respectively.

In the first embodiment shown in FIG. 2 to which the second aspect is applied: an image signal taken at CCD 102 having a color filter disposed on the front surface thereof is digitized at an analog-to-digital converter 103 and then recorded to an image buffer 104; and surrounding pixels in a predetermined size of the same color as the fault pixel are read into a line buffer 201 by the input/output control section 200 based on the location information of the fault pixels recorded at the defect location recording ROM 205. Integrated index values are then obtained from a plurality of index values in predetermined directions at the index value computing section 202; a direction having maximum correlation is obtained at the direction computing section 203; and a correction value of the fault pixel is computed by the correction value computing section 204 by using surrounding pixels belonging to the direction having the correlation.

In this manner, a direction having high correlation is obtained from the surrounding pixels of the same color as the fault pixel and the surrounding pixels belonging to such direction are used to compute a correction value. In that process, a plurality of index values are obtained with respect to a predetermined direction and these are integrated to form an index value of such direction. Thus, the obtained index value is accurate and the efficiency in detecting the direction is high so that an accurate correction of fault pixel(s) becomes possible even in a complicated image such as an edge region.

In accordance with a third aspect of the invention, there is provided a fault pixel correcting apparatus for correcting a fault pixel in solid-state image pickup device having color filters having uneven frequencies of occurrence of colors disposed on a front surface thereof, including: defect storing means for storing location information of the fault pixel; pixel read means for reading surrounding pixels of the fault pixel based on the location information stored at the defect storing means; index value computing means for computing integrated index values from a plurality of edge intensity index values concerning predetermined directions of the pixels of color of higher occurrence frequency in the surrounding pixels read by the pixel read means; direction computing means for computing a direction having maximum correlation of the pixels of the color of higher occurrence frequency based on the integrated index values computed at the index value computing means; a first correction value computing means for computing a correction value of the fault pixel from the pixels of the color of higher occurrence frequency of the surrounding pixels selected based on the direction computed at the direction computing means; color ratio computing means for computing a color ratio from the pixels of the color of higher occurrence frequency and the pixels of a color of lower occurrence frequency in the pixels surrounding the fault pixel; a second correction value computing means for computing a correction value of the fault pixel based on an interpolated value computed from the pixels of the color of higher occurrence frequency in the pixels surrounding the fault pixel and the color ratio computed at the color ratio computing means; and changeover means for changing over between the first correction value computing means and the second correction value computing means based on the color of the fault pixel.

A second embodiment shown in FIGS. 9 to 12 corresponds to an embodiment of the fault pixel correcting apparatus according to the third aspect. Of the constituent features of the fault pixel correcting apparatus according to the third aspect: the defect storing means, pixel read means, index value computing means, direction computing means, first correction value computing means, color ratio computing means, second correction value computing means, and changeover means correspond to a defect location recording ROM 205, input/output control section 200, index value computing section 202, direction computing section 203, correction value computing section 204, color ratio computing section 207, second correction value computing section 208, and controlling section 108 of the first embodiment, respectively.

In the second embodiment shown in FIG. 9 to which the third aspect is applied: an image signal taken at CCD 102 having a color filter 109 disposed on the front surface thereof is digitized at an analog-to-digital converter 103 and then recorded to an image buffer 104; and a predetermined size of the pixels surrounding the fault pixel are read into a line buffer 201 by the input/output control section 200 based on the location information of the fault pixels recorded at the defect location recording ROM 205. If the fault pixel is a pixel of a color occurring at relatively high frequency: integrated index values are obtained from a plurality of index values in predetermined directions at the index value computing section 202; a direction having maximum correlation is obtained at the direction computing section 203; and a correction value of the fault pixel is computed at the correction value computing section 204 by using those surrounding pixels belonging to the direction having the correlation. If the fault pixel is a pixel of a color occurring at relatively low frequency: color ratio between the pixels of the color of low occurrence frequency and the pixels of the color of high occurrence frequency surrounding the fault pixel is obtained at the color ratio computing section 207; and a correction value of the fault pixel is computed by multiplying an interpolation value obtained from the pixels of the color of high occurrence frequency by the color ratio at the second correction value computing section 208.

In this manner, if the fault pixel is a pixel of the color of high occurrence frequency, a direction having high correlation is obtained by using the pixels of that color only so as to compute a correction value using those surrounding pixels belonging to this direction. In the case of a pixel of the color of low occurrence frequency, on the other hand: the color ratio is obtained between the pixels of the color of high occurrence frequency and the pixels of the color of low occurrence frequency by using the pixels surrounding the fault pixel; a pixel value of the color of high occurrence frequency at the location of the fault pixel is further obtained by an interpolation; and a correction value is computed by multiplying the obtained two by each other.

In the case of a pixel of a color of high occurrence frequency, thus, since a correction value is computed by using the pixels of that color only, an accurate correction while preserving high-frequency components becomes possible without being affected by the color of low occurrence frequency. Further, in the case of a pixel of the color of low occurrence frequency, a relatively accurate correction becomes possible by using information of the pixels of high occurrence frequency, since a correction valued is computed on the basis of the color ratio to the pixels of the more frequent color.

In accordance with a fourth aspect of the invention, the edge intensity index value in the fault pixel correcting apparatus according to the first aspect is an absolute value difference in pixel value between two pixels near the fault pixel among the normal pixels in the surrounding of the fault pixel. The first embodiment corresponds to an embodiment according to the fault pixel correcting apparatus of this aspect.

In accordance with a fifth aspect of the invention, the edge intensity index value in the fault pixel correcting apparatus according to the second or third aspect is an absolute value difference in pixel value between two pixels having the same color as and located near the fault pixel among the normal pixels in the surrounding of the fault pixel. The first and second embodiments correspond to an embodiment according to the fault pixel correcting apparatus of this aspect.

In accordance with a sixth aspect of the invention, the integrated index value in the fault pixel correcting apparatus according to any one of the first to third aspects is a value obtained by adding the edge intensity index values in each of the predetermined directions. The first and second embodiments correspond to an embodiment according to the fault pixel correcting apparatus of this aspect.

In accordance with a seventh aspect of the invention, the pixel read means in the fault pixel correcting apparatus according to any one of the first to third aspects includes an elimination means for, when a fault pixel is included in the surrounding pixels, eliminating the fault pixel based on the location information of the fault pixel. The first and second embodiments correspond to an embodiment related to the fault pixel correcting apparatus of this aspect; and a surrounding defect eliminating section 206 in the first and second embodiments corresponds to the elimination means in the constituent features of the fault pixel correcting apparatus of this aspect.

In the first and second embodiments shown in FIGS. 2 and 9, respectively, to which this aspect is applied: surrounding pixels in a predetermined size are read at the input/output control section 200 based on the location information of the fault pixels recorded on the defect location recording ROM 205; and fault pixels are eliminated from the surrounding pixels at the surrounding defect eliminating section 206 based on the location information of the fault pixels recorded on the defect location recording ROM 205. A correction value is obtained after eliminating fault pixels existing in the surrounding pixels of the fault pixel. An accurate correction even in the case of successive occurrence of fault pixels is thereby possible by eliminating an effect therefrom.

In accordance with an eighth aspect of the invention, the index value computing means in the fault pixel correcting apparatus according to any one of the first to third aspects includes: extraction means for extracting a plurality of a combination of two pixels located at a predetermined distance from each other from the surrounding pixels belonging to the predetermined directions; absolute value difference computing means for computing absolute value difference between pixels with respect to the plurality of combination extracted at the extraction means; and addition means for adding a plurality of absolute value differences computed at the absolute value difference computing means in each of the plurality of predetermined directions.

The first and second embodiments correspond to an embodiment relating to the fault pixel correcting apparatus according to the eighth aspect. Of the constituent features of the fault pixel correcting apparatus according to the eighth aspect, the extraction means, absolute value difference computing means, and addition means correspond to an extracted location recording ROM 300, absolute value difference computing section 301, and adding section 302, respectively, of the index value computing section 202 in the first and second embodiments.

Within the index value computing section 202 in the first and second embodiments shown in FIGS. 2 and 9, respectively, to which this aspect is applied: a plurality of sets each consisting of two pixels belonging to a certain direction are extracted from the surrounding pixels of the fault pixel based on the location information recorded on the extracted location recording ROM 300; absolute value differences are obtained with respect to the sets at the absolute value difference computing section 301; and an index value in a predetermined direction is formed by adding the absolute value differences at the adding section 302. In this manner, since an index value in one direction is computed by means of addition of a plurality of index values, the index value can be computed even when fault pixels occur in succession so that an accurate correction using a direction having high correlation becomes possible.

In accordance with a ninth aspect of the invention, the direction computing means in the fault pixel correcting apparatus according to any one of the first to third aspects includes: rate computing means for obtaining rates according to directions of the computed index values in a plurality of predetermined directions; comparison means for respectively comparing by each direction the rates of the index values in the plurality of predetermined directions obtained at the rate computing means; and output means for outputting a direction having highest correlation from the result of comparison at the comparison means.

The first and second embodiments correspond to an embodiment relating to the fault pixel correcting apparatus according to the ninth aspect. Of the constituent features of the fault pixel correcting apparatus according to the ninth aspect, the rate computing means, comparison means, and output means correspond to a rate computing section 400, comparing section 401, and outputting section 402, respectively, in the direction computing section 203 of the first and second embodiments.

Within the direction computing section 203 in the first and second embodiments shown in FIGS. 2 and 9, respectively, to which this aspect is applied: the rates according to direction are obtained at the rate computing section 400 from the index values in the respective directions computed at the index value computing section 202; the ratios of rate according to direction are compared at the comparing section 401; and a direction having high correlation or information that there is no correlation in any specific direction is outputted from the outputting section 402 based on the comparison result.

As per the above description, the respective rates are obtained from the index value of each direction and the ratios of such rates are compared with each other to output a direction having correlation or information that there is no correlation. In this manner, since the values of ratio of the index values of the respective directions are compared with each other, a direction having high correlation can be accurately detected without depending, for example, on the width of gradation of the image, without requiring such adjustments as setting of a threshold, and at the same time with less likelihood of being affected by noise or the like.

In accordance with a tenth aspect of the invention, the correction value computing means or the first correction value computing means of the fault pixel correcting apparatus according to any one of the first to third aspects includes: interpolation computing means for computing a correction value by using interpolation from the surrounding pixels belonging to a predetermined direction; average computing means for computing a correction value by using an average from the surrounding pixels; and selection means for selecting the interpolation computing means or the average computing means based on the direction.

The first and second embodiments correspond to an embodiment relating to the fault pixel correcting apparatus according to the tenth aspect. Of the constituent features of the fault pixel correcting apparatus according to the tenth aspect, the interpolation computing means, average computing means, and selection means correspond to an interpolation computing section 501, average computing section 502, and selecting section 500, respectively, in the correction value computing section 204 of the first and second embodiments.

Within the correction value computing section 204 in the first and second embodiments shown in FIGS. 2 and 9, respectively, to which this aspect is applied, the interpolation computing section 501 or the average computing section 502 is selected at the selecting section 500 based on information from the direction computing section 203. In this manner, switching is made on the basis of presence/absence of correlation between an interpolation using the surrounding pixels in a specific direction and an averaging using all the surrounding pixels. If there is, for example, an edge where high correlation occurs in a certain direction, the surrounding pixels in that direction are used. If flat, all the surrounding pixels are used. An optimal correction for the input image thus becomes possible.

In accordance with an eleventh aspect of the invention, the color ratio computing means in the fault pixel correcting apparatus according to the third aspect includes a ratio computing means for computing the ratio between an average value of pixels of the color of high occurrence frequency and an average value of pixels of the color of low occurrence frequency among the pixels surrounding the fault pixel.

The second embodiment corresponds to an embodiment relating to the fault pixel correcting apparatus according to the eleventh aspect. Of the constituent features of the fault pixel correcting apparatus according to the eleventh aspect, the ratio computing means corresponds to a ratio computing section 602 in the color ratio computing section 207 of the second embodiment.

Within the color ratio computing section 207 in the second embodiment shown in FIG. 9 to which this aspect is applied: an average of the pixels of the color of high occurrence frequency is computed at a first average computing section 600 based on information from the direction computing section 203; an average of the pixels of the color of low occurrence frequency is computed at a second average computing section 601 based on information from the direction computing section 203; and the ratio of the two averages is computed at a ratio computing section 602. In this manner, a color ratio of the pixels of the color of high occurrence frequency and the pixels of the color of low occurrence frequency are computed from the surrounding pixels belonging to a direction having high correlation. Accordingly, an accurate computation of color ratio is possible even in a complicated image, for example, having an edge region.

In accordance with a twelfth aspect of the invention, the second correction value computing means in the fault pixel correcting apparatus according to the third aspect includes: interpolation computing means for computing an interpolation value by an interpolation from the pixels of the color of high occurrence frequency belonging to the predetermined direction in the surrounding pixels; average computing means for computing an interpolation value by averaging from the pixels of the color of high occurrence frequency in the surrounding pixels; selection means for looking into the direction having correlation to select one from the interpolation computing means and the average computing means; and multiplication means for multiplying the interpolation value by the color ratio.

The second embodiment corresponds to an embodiment relating to the fault pixel correcting apparatus according to the twelfth aspect. Of the constituent features of the fault pixel correcting apparatus according to the twelfth aspect, the interpolation computing means, average computing means, selection means, and multiplication means correspond to an interpolation computing section 701, average computing section 702, selecting section 700, and multiplying section 703, respectively, in the second correction value computing section 208 of the second embodiment.

Within the second correction value computing section 208 in the second embodiment shown in FIG. 9 to which this aspect is applied: the interpolation computing section 701 or the average computing section 702 is selected at the selecting section 700 to obtain an interpolation value of pixel of the color of high occurrence frequency; and it is multiplied by the color ratio from the color ratio computing section 207. In this manner, an interpolation value of the pixel of the color of high occurrence frequency is obtained from the surrounding pixels belonging to a direction having high correlation and is multiplied by the color ratio. Accordingly, an interpolation value of the pixel of the color of high occurrence frequency is obtained to obtain, based on this, a correction value of the pixel of the color of low occurrence frequency by using, in the case, for example, of an edge where high correlation occurs in a certain direction, the surrounding pixels in that direction or, if flat, using all the surrounding pixels. An optimal correction is thus possible by fully using information of the pixels of the color of high occurrence frequency.

### BRIEF DESCRIPTION OF THE DRAWINGS

FIGS. 1a and 1b show examples of patterns which respectively can and cannot be dealt with by pattern recognition according to a conventional technique.

FIG. 2 is a block diagram showing a first embodiment of the fault pixel correcting apparatus according to the invention.

FIGS. 3A to 3E show an example of fault pixel position and index value computing pixels in the respective directions of a black-and-white CCD in the first embodiment shown in FIG. 2.

FIG. 4 is a block diagram showing an example of construction of the index value computing section in the first embodiment shown in FIG. 2.

FIG. 5 shows an example of location information to be recorded in the extracted location recording ROM in the index value computing section shown in FIG. 4.

FIG. 6 is a block diagram showing an example of construction of the direction computing section in the first embodiment shown in FIG. 2.

FIG. 7 is a block diagram showing an example of construction of the correction value computing section in the first embodiment shown in FIG. 2.

FIGS. 8A to 8C show an example of fault pixel position and index value computing pixels in the respective directions of a complementary-color CCD.

FIG. 9 is a block diagram showing a second embodiment of the invention.

FIGS. 10A to 10E show an example of fault pixel positions, index value computing pixels, and an interpolation value of G at the defect location in a primary-color CCD.

FIG. 11 is a block diagram showing an example of construction of the color ratio computing section in the second embodiment shown in FIG. 9.

FIG. 12 is a block diagram showing an example of construction of the second correction value computing section in the second embodiment shown in FIG. 9.

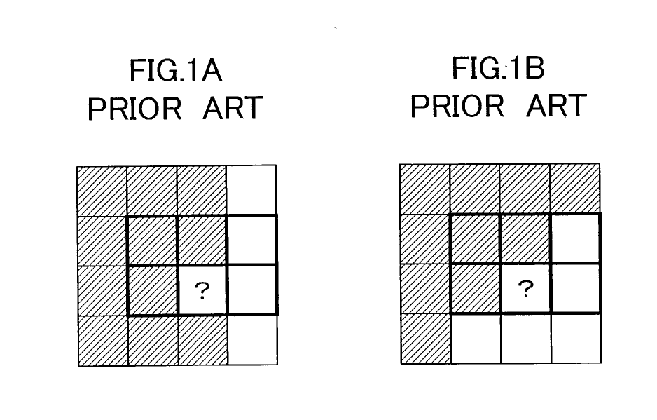

### DESCRIPTION OF THE PREFERRED EMBODIMENTS

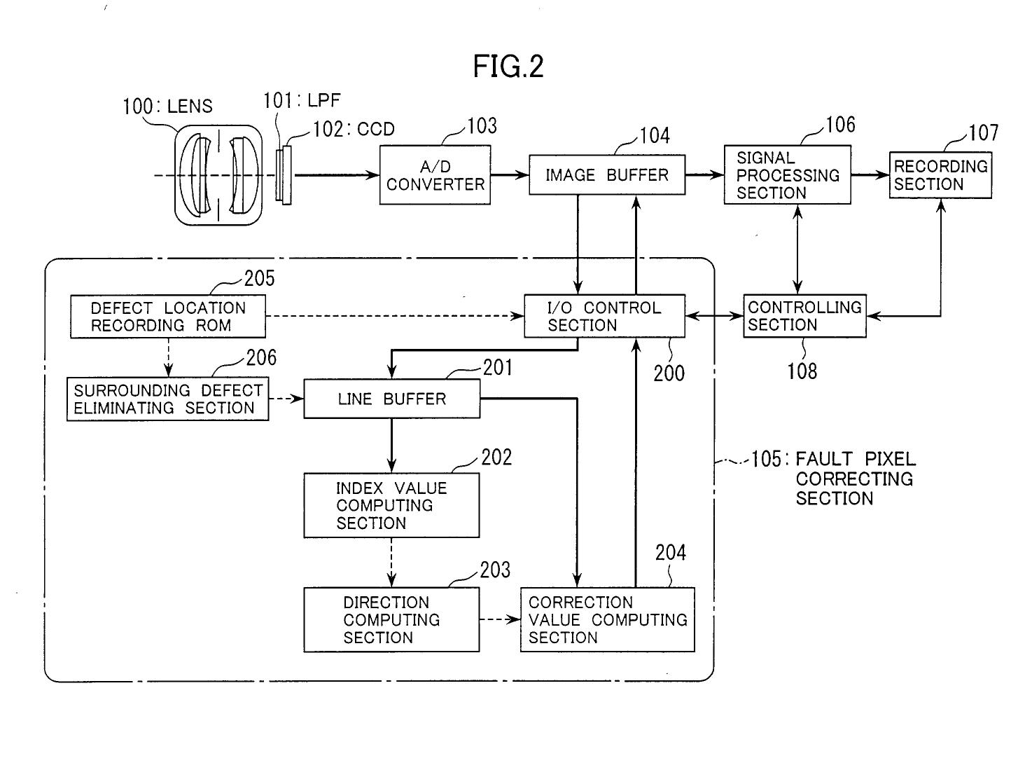

An embodiment of the present invention will now be described. FIG. 2 is a block diagram showing a first embodiment of the fault pixel correcting apparatus according to the invention. FIG. 2 includes: a lens system 100; a low-pass filter 101; and CCD 102. An image picked up via the CCD 102 is converted into digital signals at an analog-to-digital converter 103. The image signal from the analog-to-digital converter 103 is then transferred to a fault pixel correcting section 105 via an image buffer 104 and the signal after correction is transmitted again to the image buffer 104. The signal from the image buffer 104 is inputted to a recording section 107 such as a memory card or disk via a signal processing section 106.

The fault pixel correcting section 105 includes an input/output control section 200 which is connected to the image buffer 104, a line buffer 201 which is connected to the image buffer 104 via the input/output control section 200, an index value computing section 202, a direction computing section 203, and a correction value computing section 204. An output of the correction value computing section 204 is connected to the image buffer 104 via the input/output control section 200. Further, a defect location recording ROM 205 is connected to the input/output control section 200 and to a surrounding defect eliminating section 206, and the surrounding defect eliminating section 206 is connected to the line buffer 201. The line buffer 201 is further connected to the correction value computing section 204. A controlling section 108, for example, of a microcomputer is interconnected to the signal processing section 106, to the recording section 107, and to the input/output control section 200.

A summary of the operation of the first embodiment shown in FIG. 2 will now be described based on the flow of signals. It is to be noted that, in FIG. 2, image signals are indicated by thick lines, control signals by thin lines, and other data by dotted lines. In the block diagrams hereinafter, signals will be similarly indicated. First, the system is caused to enter an image taking mode when a shutter button (not shown) is pressed. An image taken through the lens system 100, low-pass filter 101, and CCD 102 is converted into digital signals at the analog-to-digital converter 103 and then transmitted to the image buffer 104. In this embodiment, gradations of digitized image signal are, for example, ten (10) bits. The image signal within the image buffer 104 is transmitted to the fault pixel correcting section 105 under the control of the controlling section 108 and is corrected of fault pixels. The result of such correction is transmitted to the image buffer 104. When correction of all fault pixels has been complete, the image signal in the image buffer 104, under the control of the controlling section 108, is transmitted to the signal processing section 106 to be subjected to known signal processing such as edge enhancement and γ correction and is transmitted to and recorded at the recording section 107.

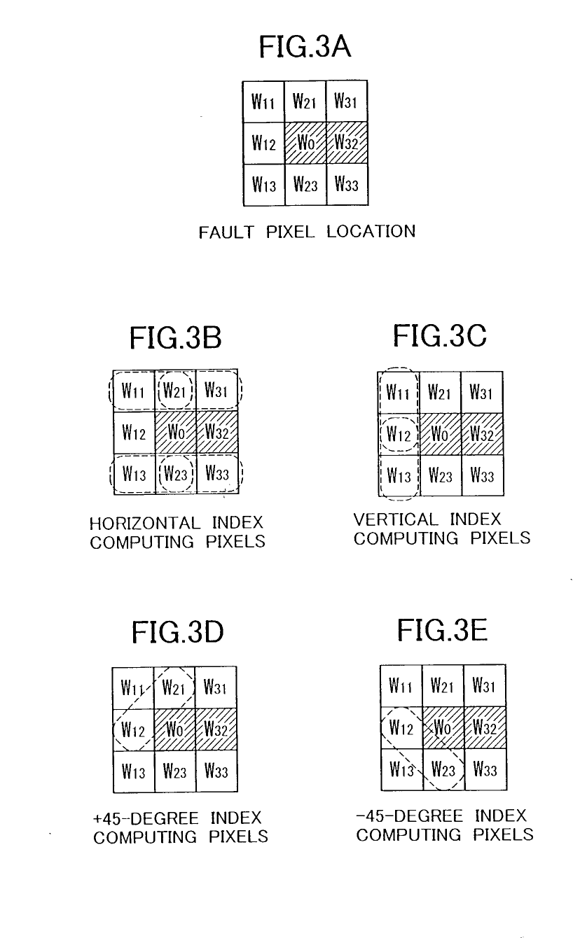

The correction of fault pixel in this embodiment will now be described. FIGS. 3A to 3E show an example of fault pixel in CCD 102 used in this embodiment. It is to be noted that, in this illustrative example, a black-and-white CCD without a color filter is used. FIG. 3A shows a fault pixel W₀ and surrounding pixels W₁ⱼ (i=1 to 3, j=1 to 3) in a 3×3-pixel array adjoining thereto. In this illustrative example, W₃₂ adjoining the fault pixel W₀ to be observed is also a fault pixel and is indicated by hatching. The location information of the fault pixels obtained by a previous inspection is recorded at the defect location recording ROM 205 within the fault pixel correcting section 105. The input/output control section 200 sequentially reads the location information of the fault pixels from the defect location recording ROM 205 under the control of the controlling section 108 and transmits to the line buffer 201 surrounding pixels in a predetermined size or 3×3 pixels in this example around the fault pixel.

The surrounding defect eliminating section 206 reads the location information of the fault pixels from the defect location recording ROM 205 and, if a fault pixel occurs in the surrounding pixels, replaces the value of such surrounding pixel by a certain identification value. The identification value is arbitrary unless it is not among those values to be outputted by the analog-to-digital converter 103. For example, “−1” is used in this example. The index value computing section 202 then reads the fault pixel and the surrounding pixels on the line buffer 201 to compute index values concerning predetermined directions.

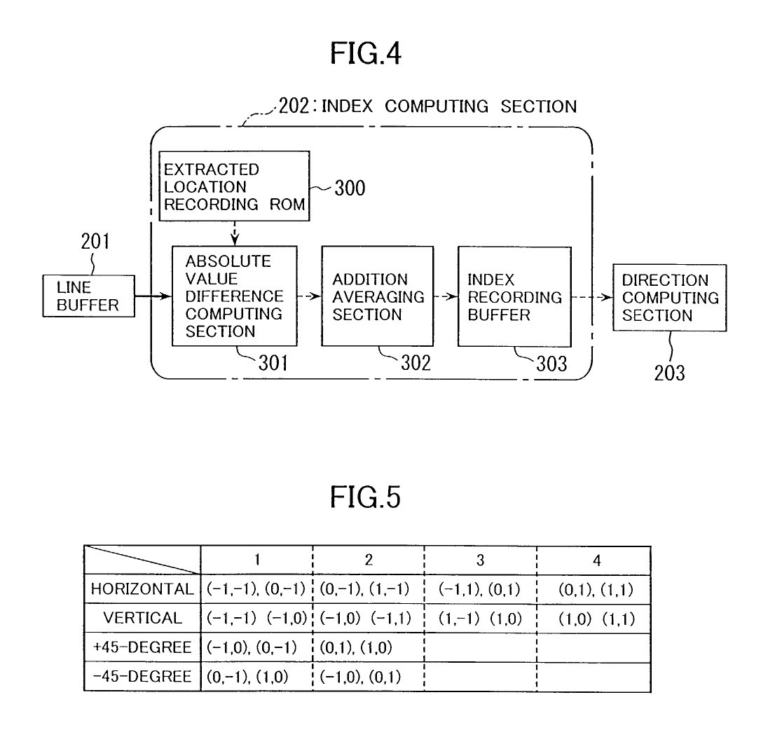

FIG. 4 is a block diagram showing a typical construction of the index value computing section 202. It includes: extracted location recording ROM 300; absolute value difference computing section 301; addition averaging section 302; and index value recording buffer 303. Signals from the line buffer 201 are connected to the direction computing section 203 through the absolute value difference computing section 301, addition averaging section 302, and the index value recording buffer 303. Further, the extracted location recording ROM 300 is connected to the absolute value difference computing section 301. The fault pixel and surrounding pixels within the line buffer 201 are read into the absolute value difference computing section 301, and an index value based on absolute value difference is computed for each of the predetermined directions in accordance with the location information recorded to the extracted location recording ROM 300.

FIG. 5 shows an example of the location information to be recorded to the extracted location recording ROM 300, where the location information of horizontal and vertical directions and of 45-degree oblique directions is recorded. The location information is recorded as relative coordinates where the coordinate of the fault pixel to be observed is determined as the origin. The absolute value difference computing section 301 first reads the location information in the horizontal direction from the extracted location recording ROM 300 to compute absolute value differences. FIG. 3B shows four pairs of index value computing pixels in the horizontal direction in this example. The above absolute value differences are added together at the addition averaging section 302 and recorded onto the index value recording buffer 303. A horizontal index value rₕ is obtained by formula (1).

rₕ=(|W₁₁−W₂₁|+|W₂₁−W₃₁|+|W₁₃−W₂₃|+|W₂₃−W₃₃|)/4 (1)

Next, the absolute value difference computing section 301 reads the location information in the vertical direction from the extracted location recording ROM 300 to compute absolute value differences. It is to be noted that, in this example, W₃₂ adjoining the fault pixel W₀ is also a fault pixel and an identification value “−1” is substituted for by the surrounding defect eliminating section 206. When a pixel substituted by the above identification value is detected, the absolute value difference computing section 301 suspends the computation of the absolute value difference and proceeds to another pair. FIG. 3C shows the two pairs of index value computing pixels in the vertical direction in this example. Thereafter, an index value is computed in a similar manner as the horizontal method and recorded to the index value recording buffer 303. A vertical index value rᵥ is obtained by formula (2).

rᵥ=(|W₁₁−W₁₂|+|W₁₂−W₁₃|)/2 (2)

The index values by directions on the index value recording buffer 303 are transferred to the direction computing section 203. In a similar manner, the absolute value difference computing section 301 reads the location information of 45-degree oblique directions from the extracted location recording ROM 300 to compute absolute value differences. In this example, since W₃₂ adjoining the fault pixel W₀ is also a fault pixel, the computation of absolute value difference is suspended and the processing proceeds to another pair. FIGS. 3D and 3E show the two pairs of index value computing pixels of the 45-dgree oblique directions in this example. Thereafter, the computed index values are recorded onto the recording buffer 303. The index values rᵤ and r_{d} in the 45-degree oblique directions are obtained by formulas (3), (4).

rᵤ=|W₂₁−W₁₂| (3)

r_{d}=|W₁₂−W₂₃| (4)

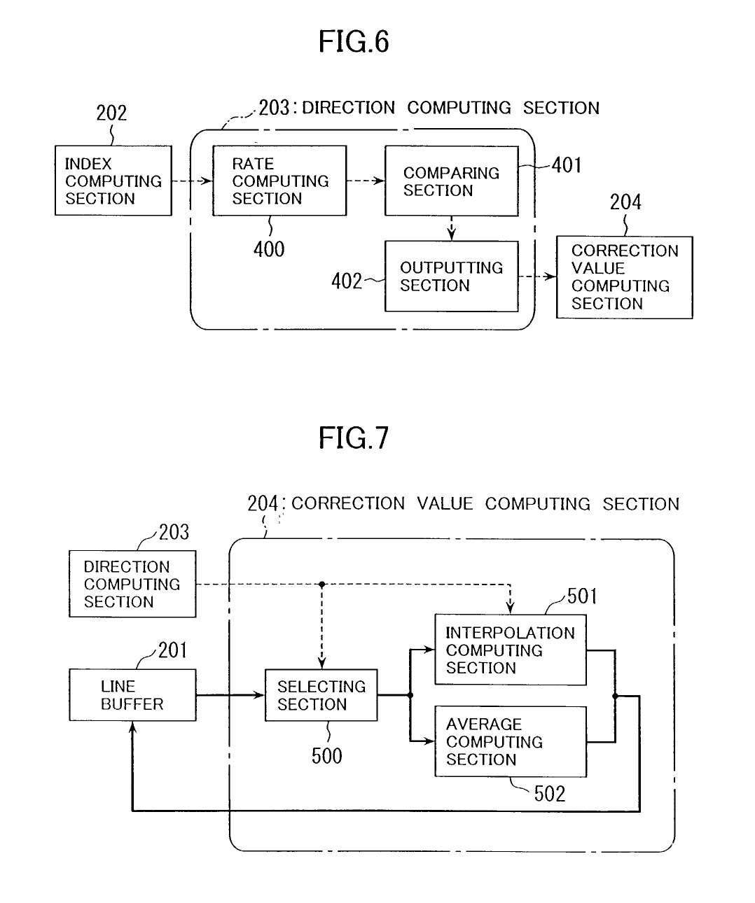

FIG. 6 is a block diagram showing an example of construction of the direction computing section 203 which includes: a rate computing section 400; a comparing section 401; and an outputting section 402. The index values from the index value computing section 202 are connected to the correction value computing section 204 through the rate computing section 400, comparing section 401, and outputting section 402. Of the index values by directions from the index value computing section 202, the rates of index values concerning a plurality of predetermined directions are computed at the rate computing section 400 and are transmitted to the comparing section 401. At the comparing section 401, the rates of index values concerning the predetermined directions are compared for each direction. The result thereof is transmitted to the outputting section 402. The outputting section 402 outputs a direction having highest,correlation. If, after the comparison, the correlation concerning none of the directions is very high, an information is outputted to the correct value computing section 204 that correlation concerning a certain direction is absent.

FIG. 7 is a block diagram showing an example of construction of the correction value computing section 204 which includes a selecting section 500, an interpolation computing section 501, and an average computing section 502. Signals from the line buffer 201 are connected to the interpolation computing section 501 or to the average computing section 502 through the selecting section 500, and the interpolation computing section 501 and average computing section 502 are connected to the line buffer 201. Further, direction information of the direction computing section 203 is connected to the selecting section 500 and to the interpolation computing section 501. When a certain direction is designated based on the direction information of the direction computing section 203, the selecting section 500 selects the surrounding pixels in such direction and transmits them to the interpolation computing section 501. On the other hand, if a certain direction is not outputted by the direction computing section 203, all the surrounding pixels are selected and transmitted to the average computing section 502. The interpolation computing section 501 computes a correction value of the fault pixel, for example, by using a known linear interpolation. The average computing section 502 computes a correction value of the fault pixel by the means of added average or median of the surrounding pixels, mode, etc. It is to be noted that, when the identification value has been substituted for a surrounding pixel by the surrounding defect eliminating section 206, such surrounding pixel is not used.

A correction value v of the fault pixel is determined by one of the following formulas (5) to (8).

v=W₁₂:[horizontal direction] (5)

v=(W₂₁+W₂₃)/2:[vertical direction] (6)

v=(W₃₁+W₁₃)/2:[plus 45-degree direction] (7)

v=(W₁₁+W₃₃)/2:[minus 45-degree direction] (8)

v=(W₁₁+W₂₁+W₃₁+W₁₂+W₁₃+W₂₃+W₃₃)/7:[flat (average)] (9)

Further, in some cases, formula (9) is replaced by formula (10).

v=median [W₁₁,W₂₁,W₃₁,W₁₂,W₁₃,W₂₃,W₃₃]:[flat (median)] (10)

The correction value is transmitted to the image buffer 104 through the input/output control section 200. The controlling section 108 effects control so that the above process is repeated for all of the fault pixels on the defect-location recording ROM 205. By the above construction, even when fault pixels occur in succession, a correction value can be obtained from the surrounding pixels in a certain direction based on index value so that a high-quality correction of fault pixel becomes possible.

Further, since the absence of a conspicuous correlation is regarded as flat so that a correction value is obtained from all of the surrounding pixels, an optimal correction suitable to the image is possible and an erroneous operation resulting from noise can also be reduced.

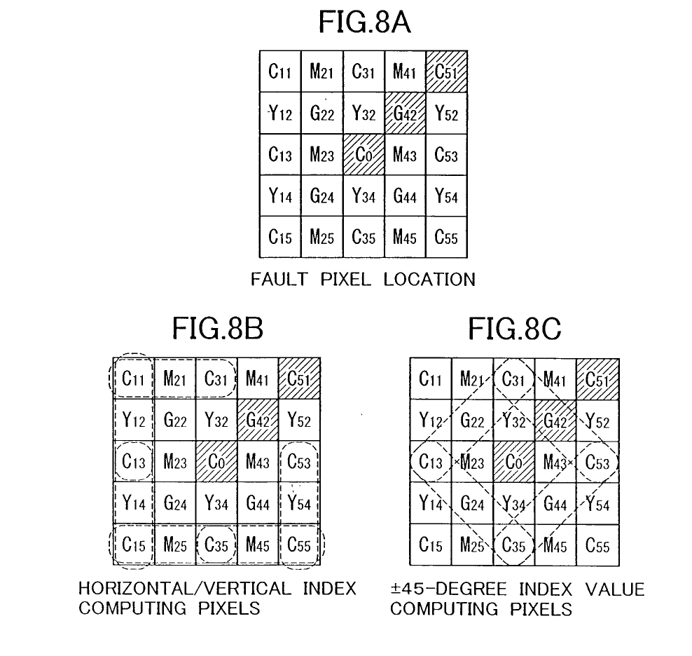

While the case of black-and-white CCD has been supposed in describing the present embodiment, it is not limited to this. For example, it can be applied also to a complementary-color, single-sensor CCD where, as shown in FIG. 8A, color filters of cyan (C), magenta (M), yellow (Y), green (G) are disposed on the front surface of CCD. In the example shown in FIG. 8A, the fault pixel C₀ to be observed, and C₅₁ and G₄₂ are fault pixels. In this example, it is supposed that the input/output control section 20 reads a 5×5 pixel size as the surrounding pixels. FIGS. 8B and 8C show the location information of the sets in computing the index values by directions at the index value computing section 202. In particular, FIG. 8B shows the index value computing pixels in the horizontal and vertical directions, and FIG. 8C shows the index value computing pixels in ±45-degree directions. The index values rₕ, rᵥ, rᵤ, r_{d} of the respective directions are expressed as in the following formulas (11) to (14).

rₕ=(|C₁₁−C₃₁|+|C₁₅−C₃₅|+|C₃₅−C₅₅|)/3:[horizontal direction] (11)

rᵥ=(|C₁₁−C₁₃|+|C₁₃−C₁₅|+|C₅₃−C₅₅|)/3:[vertical direction] (12)

rᵤ=(|C₃₁−C₁₃|+|C₅₃−C₃₅|)/2:[+45-degree direction] (13)

r_{d}=(|C₃₁−C₅₃|+|C₁₃−C₃₅|)/2:[−45-degree direction] (14)

The information of these coordinates is recorded to the extracted location recording ROM 300 based on the arrangement of color filters.

Further, a correction value v of the fault pixel is determined by one of the following formulas (15) to (19).

v=(C₁₃+C₅₃)/2:[horizontal direction] (15)

v=(C₃₁+C₃₅)/2:[vertical direction] (16)

v=(C₁₅:[+45-degree direction] (17)

v=(C₁₁+C₅₅)/2:[−45-degree direction] (18)

v=(C₁₁+C₃₁+C₁₃+C₅₃+C₁₅+C₃₅+C₅₅)/7:[flat (average)] (19)

Further, in some cases, formula (19) is replaced by formula (20).

v=median [C₁₁,C₃₁,C₁₃,C₅₃,C₁₅,C₃₅,C₅₅]:[flat (median)] (20)

As per the above, the present embodiment is applicable also to an image pickup device having a color filter disposed over the front surface thereof. While an absolute value difference between two pixels has been used in the present embodiment to obtain an index value, it is not limited to this. Other methods such as use of a ratio of the two pixels can also be used. Further, while added averaging has been used to integrate each index value, it is not limited to this. Such other methods as use of weighted values according to distance from the fault pixel to be observed can also be used.

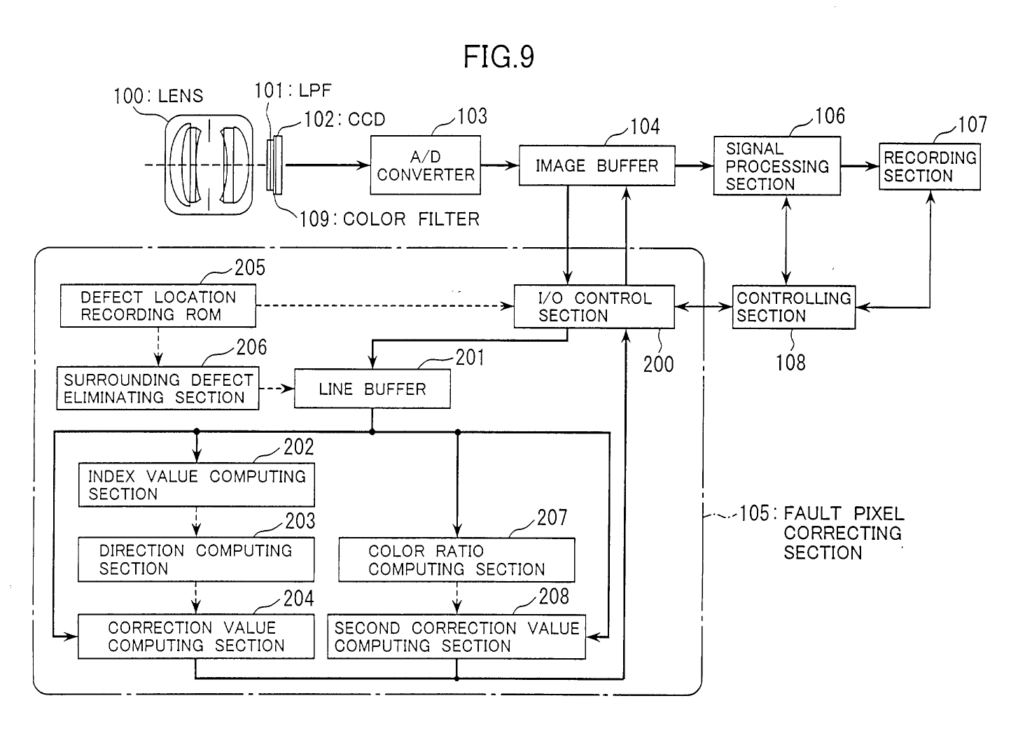

A second embodiment of the present invention will now be described with reference to the block diagram of FIG. 9. In the construction of this embodiment, a color filter 109 is added to the CCD 102 in the first embodiment and a color ratio computing section 207 and a second correction value computing section 208 are added to the fault pixel correcting section 105. Its fundamental construction is an equivalent to that of the first embodiment and like components are denoted by like numerals and names.

The construction will be described below mainly of those components that are different from the first embodiment. A color filter 109 is disposed between the low-pass filter 101 and CCD 102. At the fault pixel correcting section 105, the line buffer 201, index value computing section 202, direction computing section 203, and correction value computing section 204 are connected to the image buffer 104 via the input/output control section 200. The output of the correction value computing section 204 is connected to the image buffer 104 through the input/output control section 200. Further, a connection is made from the line buffer 201 to a color ratio computing section 207 and a second correction value computing section 208. The output of the second correction value computing section 208 is connected to the image buffer 104 via the input/output control section 200. The line buffer 201 is connected also to the correction value computing section 204 and to the second correction value computing section 208. Further, the defect location recording ROM 205 is connected to the input/output control section 200 and to the surrounding defect eliminating section 206. The surrounding defect eliminating section 206 is connected to the line buffer 201.

The operation of the second embodiment having such construction will now be described. The operation of this embodiment is fundamentally an equivalent to that of the first embodiment and will be described below mainly with respect to those portions different therefrom. Referring to FIG. 9, the system is caused to enter an image taking mode when a shutter button (not shown) is pressed. An image taken through the lens system 100, low-pass filter 101, color filter 109 and CCD 102 is converted into digital signals at the analog-to-digital converter 103 and is transmitted to the image buffer 104. The image signal within the image buffer 104 is transmitted to the fault pixel correcting section 105 under the control of the controlling section 108 and is corrected of fault pixels. The result of such correction is transmitted to the image buffer 104. When correction of all fault pixels has been complete, the image signal in the image buffer 104, under the control of the controlling section 108, is transmitted to the signal processing section 106 to be subjected to known signal processing such as interpolation, white balance, edge enhancement and γ correction and is transmitted to and recorded at the recording section 107.

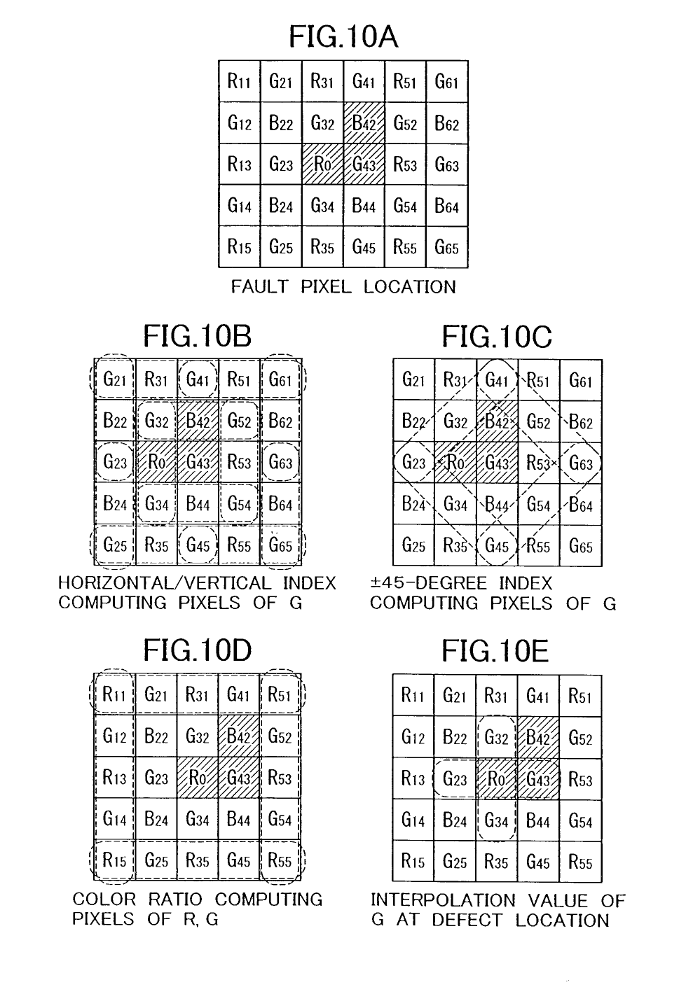

FIGS. 10A to 10E show an example of fault pixel in CCD 102 used in the present embodiment. In this example, a Bayer-type primary-color CCD consisting of red (R), green (G) and blue (B) is used. The Bayer-type CCD has uneven frequencies of occurrence where G pixel occurs twice as frequent as R, B pixels. FIG. 10A shows fault pixels R₀, G₄₃, B₄₂ as included in the surrounding pixels of 6×5 pixel size in their vicinity. First, the correction will be described of the case where a signal of high occurrence frequency is defective. In this example, the case of correcting the fault pixel G₄₃ in FIG. 10A is considered. In the defect location recording ROM 205 within the fault pixel correcting section 105, the location information of fault pixels obtained by a previous G which is the pixel of color of high occurrence frequency and R, B which are the pixels of colors of low occurrence frequency.

The input/output control section 200, under the control of the controlling section 108, sequentially reads location information of fault pixels concerning G pixels from the defect location recording ROM 205 and transmits to the line buffer 201 only those G pixels in the surrounding pixels of a predetermined size around the fault pixel, in this example, of 5×5 pixel size. Further, the surrounding defect eliminating section 206 reads the location information of the fault pixels from the defect location recording ROM 205 and, when a fault pixel occurs in G pixels of the surrounding pixels, replaces the value of such surrounding pixel with a specific identification value. FIG. 10B shows pixel location information of sets in computing index values in the two directions of horizontal and vertical and FIG. 10C shows index values in the two directions of +45-degrees and −45-degrees.

Thereafter, a correction value of the fault pixel is computed at the correction value computing section 204 by using pixels of the direction outputted from the direction computing section 203, or, when no specific direction is outputted from the direction computing section 203, a correction value of the fault pixel is computed by using all the pixels adjoining to the fault pixel (G₃₂, G₅₂ G₃₄, G₅₄ in this example). The computed correction value of the fault pixel is then transmitted to the image buffer 104 via the input/output control section 200. The controlling section 108 effects control so as to repeat the above process with respect to all the fault pixels of G pixels on the defect location recording ROM 205.

The correction will now be described of a fault pixel of R, B pixels which are the pixels of the colors of low occurrence frequency. While a description will be given below with respect to an R pixel, it is similarly applicable also to a B pixel. The case of correcting R₀ in FIG. 10A will be used as an example. The input/output control section 200, under the control of the controlling section 108, sequentially reads location information of fault pixels concerning R and G pixels from the defect location recording ROM 205 and transmits to the line buffer 201 those R pixels and G pixels in the surrounding pixels of a predetermined size around the fault pixel, in this example, of 5×5 pixel size. Further, the surrounding defect eliminating section 206 reads location information of fault pixels from the defect location recording ROM 205 and, when a fault pixel occurs in the surrounding pixels, replaces the value of such surrounding pixel by a specific identification value.

By using the readout pixels of 5×5 pixel size on the line buffer 201, a color ratio between R and G is computed at the color ratio computing section 207 from the added value of R pixels which occur at low frequency and the added value of G pixels which occur at high frequency. At the second correction value computing section 208, an interpolation value of high occurrence frequency signal (G signal) at the location of the fault pixel (R₀) to be corrected is obtained from the high occurrence frequency signals (G signals) adjoining to the fault pixel (R₀) and is multiplied by the color ratio outputted by the color ratio computing section 207 to obtain a correction value of the fault pixel (R₀ ). If a fault pixel is contained in the pixels to be used, however, such pixel is not used.

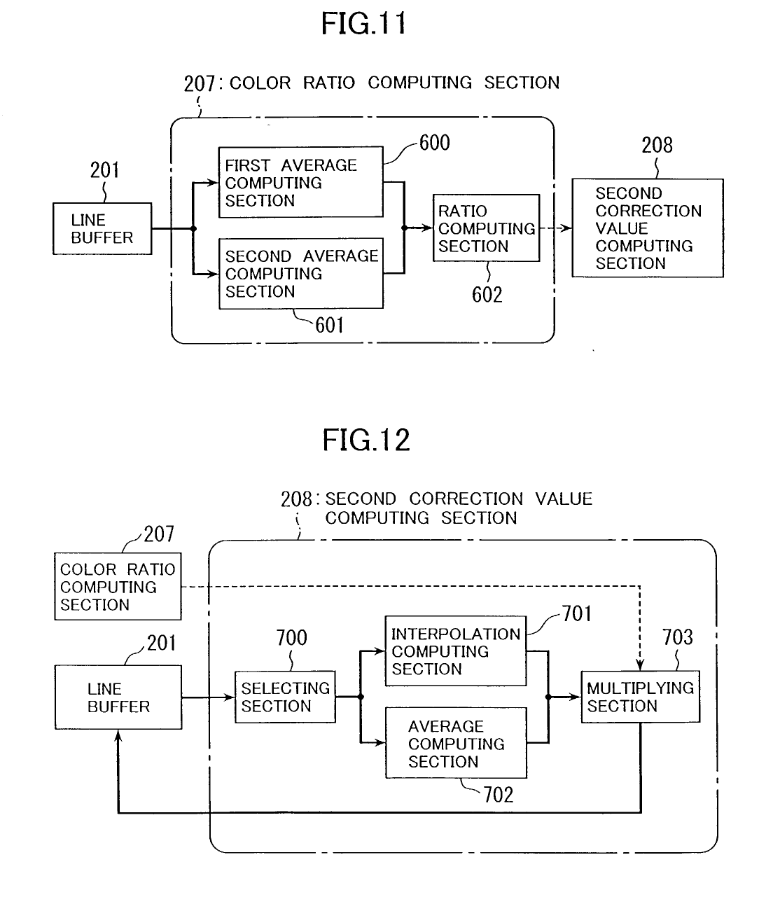

FIG. 11 is a block diagram showing an example of construction of the color ratio computing section 207 which includes a first average computing section 600, a second average computing section 601, and a ratio computing section 602. Signals from the line buffer 201 are connected to the ratio computing section 602 through the first average computing section 600 or through the second average computing section 601, and the ratio computing section 602 is connected to the second correction value computing section 208. The G pixels in the surrounding pixels within the line buffer 201 are read into the first average computing section 600 and an average value is computed from G pixels that are not adjoining to the fault pixel. Similarly, the R pixels in the surrounding pixels within the line buffer 201 are read into the second average computing section 601 and an average value is computed from R pixels that are not adjoining to the fault pixel. The average values from the first average value computing section 600 and the second average value computing section 601 are subjected to division at the ratio computing section 602 to compute a color ratio which is transmitted to the second correction value computing section 208. FIG. 10D shows the R, G pixels to be used in obtaining the above color ratio. In this example, color ratio r_{c} is expressed by the following formula (21).

r_{c}={(R₁₁+R₃₁+R₅₁+R₁₃+R₅₃+R₁₅+R₃₅+R₅₅)/8}/{(G₂₁+G₄₁+G₁₂+G₅₂+G₁₄+G₅₄+G₂₅+G₄₅)/8} (21)

However, if a fault pixel is included in the pixels to be used in formula (21), such pixel is not used.

FIG. 12 is a block diagram showing an example of construction of the second correction value computing section 208 which includes a selecting section 700, an interpolation computing section 701, an average computing section 702, and a multiplying section 703. Signals from the line buffer 201 are connected to the interpolation computing section 701 and average computing section 702 through the selecting section 700. The interpolation computing section 701 and average computing section 702 are connected to the multiplying section 703. The multiplying section 703 is connected to the line buffer 201. Further, signal of the color ratio computing section 207 is connected to the multiplying section 703.

The G pixels in the surrounding pixels within the line buffer 201 are read into the interpolation computing section 701 or into the mean value computing section 702 through the selecting section 700. At the selecting section 700, differences in pixels of the two pixels sandwiching the fault pixel are compared. If a correlation in horizontal direction or vertical direction is recognized, those G pixels adjoining to the fault pixel and belonging to such direction are transmitted to the interpolation computing section 701. In the absence of correlation in any specific direction, all G pixels adjoining to the fault pixel are transmitted to the average computing section 702. An interpolation value is computed at the interpolation computing section 701, for example, by known linear interpolation. An average value is computed at the average computing section 702. These are transmitted to the multiplying section 703. FIG. 10E shows pixels to be used in obtaining an interpolation value at the defect location of a G pixel which occurs at high frequency. In this example, since G₄₃ is a fault pixel, G₃₂, G₃₄ are used if a correlation exists in the vertical direction. G₂₃ is used if a correlation exists in the horizontal direction. In the case of an absence of correlation in any specific direction, G₃₂, G₃₄, G₂₃ are used.

At the multiplying section 703, the signal from the interpolation computing section 701 or from the average computing section 702 is multiplied by the color ratio from the color ratio computing section 207 to obtain a correction value of the fault pixel (R₀). In this example, a correction value v is obtained by one of the following formulas (22) to (24).

v=r_{c}×G₂₃:[horizontal direction] (22)

v=r_{c}×(G₃₂+G₃₄)/2:[vertical direction] (23)

v=r_{c}×(G₃₂+G₂₃+G₃₄)/3:[average] (24)

It is to be noted that, while average value of adjoining pixels has been used in formula (24), a median or mode of the adjoining pixels may be used in some cases. The controlling section 108 effects control so as to repeat the above process for all fault pixels of R, B pixels on the defect location recording ROM 205.

By the above construction, for a pixel of color of high occurrence frequency in an image pickup device having color filters of uneven occurrence frequencies disposed on the front surface thereof, a correction value can be obtained from surrounding pixels in a certain direction based on an index value of edge intensity by using only the pixels of such color of high occurrence frequency. A high-quality correction of fault pixel thus becomes possible without being affected by the pixels of color of low occurrence frequency. For a pixel of color of low occurrence frequency, on the other hand, a correction value of higher accuracy can be obtained by using information of pixels of the color of high occurrence frequency based on the color ratio to the pixel of the color of high occurrence frequency.

While the above embodiments have been shown as those adapted to perform processing by means of hardware, they are not limited to such. The present invention is also applicable, for example, to a configuration where the image is outputted in a raw format, i.e., where signals from the image pickup device are outputted in unchanged form and are subjected to software-based processing by a computer.

As has been described by way of the above embodiments, according to the first aspect of the invention, when a direction having high correlation is obtained from the surrounding pixels of the fault pixel so as to compute a correction value by using the surrounding pixels belonging to the direction, a plurality of index values are obtained with respect to a predetermined direction and are integrated to form an index value of such direction. Thus the efficiency in detecting the direction is high so that an accurate correction of fault pixel becomes possible even in a complicated image such as an edge region. According to the second aspect of the invention, in correcting fault pixel also in solid-state image pickup device having a color filter disposed on the front surface thereof, since a direction having high correlation is obtained from the surrounding pixels of the same color as the fault pixel, an accurate correction of fault pixel similarly becomes possible even in a complicated image such as an edge region.

Further, according to the third aspect of the invention, in correcting fault pixel also in solid-state image pickup device having a color filter having uneven frequencies of occurrence disposed on the front surface thereof, since, for a pixel of a color of higher occurrence frequency, a correction value is computed by using pixels of the same color as the fault pixel only, an accurate correction with preserving high-frequency components is possible without being affected by color of lower occurrence frequency. Further, for a pixel of the color of low occurrence frequency, since a correction value is computed based on a color ratio to the pixels of the color of high occurrence frequency, a more accurate correction of defect becomes possible by using information of the pixels of the color of high occurrence frequency. According to the fourth and fifth aspects of the invention, even when fault pixels occur in succession, computation of index values with eliminating an effect therefrom is possible so that accurate index values can be computed. According to the sixth aspect of the invention, since an index value of one direction is computed by addition of a plurality of index values, it is not likely to be affected for example by noise and an accurate index value can be obtained in a stable manner.

Further, according to the seventh aspect of the invention, since a correction value is obtained after eliminating fault pixels existing in the surrounding pixels of the fault pixel, an accurate correction of defect with eliminating an effect therefrom is possible even when fault pixels occur in succession. According to the eighth aspect of the invention, since an index value of one direction is computed by addition of a plurality of index values, computation of index value is possible even when fault pixels occur in succession so that an accurate correction of defect using a direction having high correlation becomes possible. According to the ninth aspect of the invention, since the values of ratio of the index values of the respective directions are compared with each other, a direction having high correlation can be accurately detected without depending, for example, on the width of gradation of the image, without requiring such adjustments as setting of a threshold, and at the same time with less likelihood of being affected by noise or the like.

Further, according to the tenth aspect of the invention, an optimal correction of defect for the input image becomes possible, since, if there is, for example, an edge where high correlation occurs in a certain direction, the surrounding pixels in that direction are used and since, if flat, all the surrounding pixels are used. According to the eleventh aspect of the invention, since an accurate computation of color ratio is performed even in a complicated image such as an edge region, an accurate correction of defect becomes possible. According to the twelfth aspect of the invention, if there is, for example, an edge where high correlation occurs in a certain direction, the surrounding pixels in that direction are used to obtain a correction value. If flat, an interpolation value of pixel of the color of high occurrence frequency is obtained by using all surrounding pixels so as to obtain based on this a correction value of pixel of the color of low occurrence frequency. An optimal correction is thus possible by fully using information of the pixels of the color of high occurrence frequency.

What is claimed is:

1. A fault pixel correcting apparatus for correcting a fault pixel in solid-state image pickup device, comprising:
defect storing means for storing location information of said fault pixel;
pixel read means for reading surrounding pixels of the fault pixel based on said location information stored at the defect storing means;
index value computing means for computing integrated index values from a plurality of edge intensity index values concerning predetermined directions of said surrounding pixels read by the pixel read means;
direction computing means for computing a direction having a maximum correlation based on said integrated index values computed at the index value computing means; and
correction value computing means for computing a correction value of said fault pixel from surrounding pixels selected based on said direction computed at the direction computing means.

2. A fault pixel correcting apparatus for correcting a fault pixel in solid-state image pickup device having color filters disposed on a front surface thereof, comprising:
defect storing means for storing location information of said fault pixel;
pixel read means for reading surrounding pixels of a same color as the fault pixel of the colors of the color filters disposed on the front surface of the solid-state image pickup device based on said location information stored at the defect storing means;
index value computing means for computing integrated index values from a plurality of edge intensity index values concerning predetermined directions in the surrounding pixels of the same color as said fault pixel read by the pixel read means;
direction computing means for computing a direction having a maximum correlation based on said integrated index values computed at the index value computing means; and
correction value computing means for computing a correction value of said fault pixel from surrounding pixels selected based on said direction computed at the direction computing means.

3. A fault pixel correcting apparatus for correcting a fault pixel in solid-state image pickup device having color filters having uneven frequencies of occurrence of colors disposed on a front surface thereof, comprising:
defect storing means for storing location information of said fault pixel;
pixel read means for reading pixels surrounding the fault pixel based on said location information stored at the defect storing means;
index value computing means for computing integrated index values from a plurality of edge intensity index values concerning predetermined directions of the pixels of color of higher occurrence frequency among said surrounding pixels read by the pixel read means;
direction computing means for computing a direction having a maximum correlation of the pixels of the color of higher occurrence frequency based on said integrated index values computed at the index value computing means;
a first correction value computing means for computing a correction value of said fault pixel from the pixels of the color of higher occurrence frequency of the surrounding pixels selected based on said direction computed at the direction computing means;
color ratio computing means for computing a color ratio from the pixels of the color of higher occurrence frequency and the pixels of a color of lower occurrence frequency in said pixels surrounding the fault pixel;
a second correction value computing means for computing a correction value of said fault pixel based on an interpolated value computed from the pixels of the color of higher occurrence frequency in said pixels surrounding the fault pixel and on the color ratio computed at said color ratio computing means; and
changeover means for changing over between said first correction value computing means and said second correction value computing means based on a color of said fault pixel.

4. The fault pixel correcting apparatus according to claim 1, wherein said edge intensity index value is an absolute value difference in pixel value between two pixels near said fault pixel among normal pixels surrounding said fault pixel.

5. The fault pixel correcting apparatus according to claim 2, wherein said edge intensity index value is an absolute value difference in pixel value between two pixels having the same color as and located near said fault pixel among normal pixels surrounding said fault pixel.

6. The fault pixel correcting apparatus according to claim 3, wherein said edge intensity index value is an absolute value difference in pixel value between two pixels having the same color as and located near said fault pixel among normal pixels surrounding said fault pixel.

7. The fault pixel correcting apparatus according to claim 1, wherein said integrated index value is a value obtained by adding said edge intensity index values in each of the predetermined directions.

8. The fault pixel correcting apparatus according to claim 2, wherein said integrated index value is a value obtained by adding said edge intensity index values in each of the predetermined directions.

9. The fault pixel correcting apparatus according to claim 3, wherein said integrated index value is a value obtained by adding said edge intensity index values in each of the predetermined directions.

10. The fault pixel correcting apparatus according to claim 1, wherein said pixel read means includes an elimination means for, when a fault pixel is included in the surrounding pixels, eliminating the fault pixel based on the location information of said fault pixel.

11. The fault pixel correcting apparatus according to claim 2, wherein said pixel read means includes an elimination means for, when an additional fault pixel is included in the surrounding pixels, eliminating the additional fault pixel based on the location information of said fault pixel.

12. The fault pixel correcting apparatus according to claim 3, wherein said pixel read means includes an elimination means for, when an additional fault pixel is included in the surrounding pixels, eliminating the fault pixel based on the location information of said fault pixel.

13. The fault pixel correcting apparatus according to claim 1, wherein said index value computing means includes: extraction means for extracting a plurality of combinations of two pixels located at a predetermined distance from each other from the surrounding pixels belonging to said predetermined directions; absolute value difference computing means for computing an absolute value difference between pixels in respect of said plurality of combinations extracted at the extraction means; and addition means for adding said plurality of absolute value differences computed at the absolute value difference computing means in each of said plurality of predetermined directions.

14. The fault pixel correcting apparatus according to claim 2, wherein said index value computing means includes: extraction means for extracting a plurality of combinations of two pixels located at a predetermined distance from each other from the surrounding pixels belonging to said predetermined directions; absolute value difference computing means for computing absolute value difference between pixels in respect of said plurality of combinations extracted at the extraction means; and addition means for adding said plurality of absolute value differences computed at the absolute value difference computing means in each of said plurality of predetermined directions.

15. The fault pixel correcting apparatus according to claim 3, wherein said index value computing means includes: extraction means for extracting a plurality of combinations of two pixels located at a predetermined distance from each other from the surrounding pixels belonging to said predetermined directions; absolute value difference computing means for computing absolute value difference between pixels in respect of said plurality of combinations extracted at the extraction means; and addition means for adding said plurality of absolute value differences computed at the absolute value difference computing means in each of said plurality of predetermined directions.

16. The fault pixel correcting apparatus according to claim 1, wherein said direction computing means includes: rate computing means for obtaining rates according to directions of the computed index values in said plurality of predetermined directions; comparison means for respectively comparing by each direction the rates of the index values in said plurality of predetermined directions obtained at the rate computing means; and output means for outputting a direction having a highest correlation from the result of comparison at the comparison means.

17. The fault pixel correcting apparatus according to claim 2, wherein said direction computing means includes: rate computing means for obtaining rates according to directions of the computed index values in said plurality of predetermined directions; comparison means for respectively comparing by each direction the rates of the index values in said plurality of predetermined directions obtained at the rate computing means; and output means for outputting a direction having a highest correlation from the result of comparison at the comparison means.

18. The fault pixel correcting apparatus according to claim 3, wherein said direction computing means includes: rate computing means for obtaining rates according to directions of the computed index values in said plurality of predetermined directions; comparison means for respectively comparing by each direction the rates of the index values in said plurality of predetermined directions obtained at the rate computing means; and output means for outputting a direction having a highest correlation from the result of comparison at the comparison means.

19. The fault pixel correcting apparatus according to claim 1, wherein said correction value computing means includes: interpolation computing means for computing a correction value by an interpolation from the surrounding pixels belonging to said predetermined direction; average computing means for computing a correction value by averaging said surrounding pixels; and selection means for selecting said interpolation computing means or said average computing means based on said direction.

20. The fault pixel correcting apparatus according to claim 2, wherein said correction value computing means includes: interpolation computing means for computing a correction value by an interpolation from the surrounding pixels belonging to said predetermined direction; average computing means for computing a correction value by averaging said surrounding pixels; and selection means for selecting said interpolation computing means or said average computing means based on said direction.

21. The fault pixel correcting apparatus according to claim 3, wherein said first correction value computing means includes: interpolation computing means for computing a correction value by interpolation from the surrounding pixels belonging to said predetermined direction; average computing means for computing a correction value by averaging said surrounding pixels; and selection means for selecting said interpolation computing means or said average computing means based on said direction.

22. The fault pixel correcting apparatus according to claim 3, wherein said color ratio computing means includes ratio computing means for computing a ratio between an average value of pixels of the color of high occurrence frequency and an average value of pixels of the color of low occurrence frequency among said pixels surrounding the fault pixel.

23. The fault pixel correcting apparatus according to claim 3, wherein said second correction value computing means includes: interpolation computing means for computing an interpolation value by an interpolation from the pixels of the color of high occurrence frequency belonging to said predetermined direction in the surrounding pixels; average computing means for computing an interpolation value by averaging from the pixels of the color of high occurrence frequency in said surrounding pixels; selection means for looking into the direction having correlation to select an interpolation value from one of said interpolation computing means and said average computing means; and multiplication means for multiplying said selected interpolation value by said color ratio.

24. A method for correcting fault pixels in a solid-state image pickup device comprising:
a) storing location information relating to a location of a fault pixel;
b) reading pixels surrounding the fault pixel based on the location information;
c) computing index values based upon the intensity values of predetermined pixels read during step (b) and arranged in given directions about the fault pixel;
d) comparing the intensity values for each calculated direction of pixels to determine a direction having a maximum correlation; and
e) computing a correction value of said fault pixel from pixels surrounding the fault pixel and lying in the selected direction.

25. The method of claim 24 wherein step (e) comprises:
f) determining an interpolation based upon the intensity values of pixels which lie in said selected direction and are on opposite sides of the fault pixel.

26. The method of claim 24 wherein step (e) comprises:
f) determining one of an average and a median of the values of all pixels adjacent to the fault pixel when no maximum correlation is determined at step (d).

27. The method of claim 24 wherein step (c) comprises ignoring all other fault pixels adjoining the fault pixel being corrected when computing index values.

28. The method of claim 24 wherein filters of different colors are disposed on a front surface of the pickup device and wherein step (a) comprises storing color information of pixels together with location information; and
step (b) includes selecting those pixels having an associated color filter which is the same as the color filter associated with the fault pixel.

29. The method of claim 28 wherein the color filters have an uneven frequency of occurrence of colors disposed in said front surface and wherein step (c) comprises employing the pixels surrounding the fault pixel and having a higher frequency of occurrence to compute the index values.

30. The method of claim 24 wherein step (c) comprises:
f) obtaining an index value by determining an absolute value of a difference in intensity values of two (2) pixels lying in a given direction and adjacent said fault pixel.

31. The method of claim 30 wherein fault pixels other than the fault pixel to be corrected are ignored in obtaining an index value.

32. The method of claim 30 wherein step (f) comprises:
g) obtaining an index value by determining a sum (S) of absolute values of a difference in intensity values of a first (P₁) and a second (P₂) and a second (P₂) and a third (P₃) of three (3) pixels lying in a given direction and adjacent said fault pixel such that S=(|P₁−P₂|+|P₂−P₃|).

33. The method of claim 24 wherein step (c) comprises:
f) obtaining an index value by determining a ratio of intensity values of two (2) pixels lying in a given direction and adjacent said fault pixel.

34. The method of claim 26 wherein step (f) further comprises weighting intensity values of pixels employed in performing step (f) according to their distance from the fault pixel.

35. The method of claim 29 further comprising:
f) forming a product of the higher correlation index value and the correction value obtained in step (e).
